(19) United States
(12) Patent Application Publication
(10) Pub. No.: US 2007/0053580 A1
(43) Pub. Date: Mar. 8, 2007

(54) Image defect inspection apparatus, image defect inspection system, defect classifying apparatus, and image defect inspection method

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 11/489,868

(22) Filed: Jul. 19, 2006

(30) Foreign Application Priority Data
Sep. 5, 2005 (JP) 2005-256554

(51) Int. Cl. G06K 9/00

(52) U.S. Cl. 382/149

(57) ABSTRACT

An image defect inspection apparatus, which detects a gray level difference between corresponding pixels in two inspection images and which, if the gray level difference exceeds a detection threshold value, judges that one or the other of the pixels in the two inspection images represents a defect, comprises: a variance computing unit which computes the variance of the coordinate value of the pixel by weighting the coordinate value in accordance with the gray level difference detected for the pixel; and a detection sensitivity reducing unit which reduces the detection sensitivity for the defect as the variance increases.

### BACKGROUND OF THE INVENTION

1. Field of the Invention

The present invention relates to an image defect inspection apparatus, an image defect inspection system, and an image defect inspection method which detect a gray level difference between corresponding portions of two images, compare the detected gray level difference with a threshold value, and judge the portion under inspection to be a defect if the gray level difference is larger than the threshold value; the invention also relates to a defect classifying apparatus for classifying the thus detected defect.

2. Description of the Related Art

The present invention is directed to an image processing method and apparatus which compares corresponding portions between two images that should be the same, and judges the portion under inspection to be a defect if the difference is large. The description herein is given by taking, as an example, an appearance inspection apparatus for detecting defects in a semiconductor circuit pattern formed on a semiconductor wafer during a semiconductor manufacturing process, but the invention is not limited to this particular type of apparatus.

Generally, a bright field inspection apparatus, which illuminates the surface of a sample from a vertical direction and captures the image of its reflected light, is employed for such an appearance inspection apparatus but a dark field inspection apparatus, which does not directly capture the illumination light, can also be used. In the case of the dark field inspection apparatus, the surface of the sample is illuminated from an oblique or a vertical direction, and a sensor is disposed so as not to detect specularly reflected light; then, the dark field image of the surface of the sample is obtained by sequentially scanning the surface with the illumination light. Accordingly, certain types of dark field apparatus may not use image sensors, but it will be appreciated that the present invention is also applicable to such types of apparatus. In this way, the present invention can be applied to any image processing method and apparatus as long as the method and apparatus are designed to compare corresponding portions between two images (image signals) that should be the same and to judge the portion under inspection to be a defect if the difference is large.

In the semiconductor fabrication process, many chips (dies) are formed on a semiconductor wafer. Patterns are formed in multiple layers on each die. Each completed die is electrically tested using a prober and a tester, and any defective die is eliminated from the assembly process. In the semiconductor fabrication process, the fabrication yield is a very important factor and, therefore, the result of the electrical testing is fed back to the fabrication process and used for the management of each process step.

However, as the semiconductor fabrication process consists of many process steps, it takes a very long time before the electrical testing can be conducted after the start of the fabrication process; as a result, when, for example, process steps are found faulty as a result of the electrical testing, many wafers are already partway through the process, and the result of the electrical testing cannot be well utilized for improving the yield. To address this, in-process pattern defect inspection is performed to inspect formed patterns in the middle of the process and to detect defects, if any. If such pattern defect inspection is performed at a plurality of stages in the fabrication process, it becomes possible to detect defects that occurred after the previous inspection quickly, and the result of the inspection can thus be promptly reflected in the process management.

FIG. 1 is a block diagram showing an appearance inspection apparatus that the applicant of this patent application proposed in Japanese Unexamined Patent Publication (Kokai) No. 2004-177397. As shown, a sample holder (chuck stage) 2 is mounted on the upper surface of a stage 1 which is movable in two or three directions. A semiconductor wafer 3 to be inspected is placed on the sample holder and held fixed thereon. An imaging device 4 constructed from a one-dimensional or two-dimensional CCD camera or the like is disposed above the stage, and the imaging device 4 generates an image signal by capturing an image of the pattern formed on the semiconductor wafer 3.

As shown in FIG. 2, a plurality of dies 3a are formed on the semiconductor wafer 3 in a matrix pattern repeating in X and Y directions. As the same pattern is formed on each die, it is general practice to compare the images of corresponding portions between adjacent dies. If there is no defect in the two adjacent dies, the gray level difference between them is smaller than a threshold value, but if there is a defect in either one of the dies, the gray level difference is larger than the threshold value (single detection). At this stage, however, this is no knowing which die contains the defect; therefore, the die is further compared with a die adjacent on a different side and, if the gray level difference in the same portion is larger than the threshold value, then it is determined that the die under inspection contains the defect (double detection).

The imaging device 4 comprises a one-dimensional CCD camera, and the stage 1 is moved so that the camera moves (scans) relative to the semiconductor wafer 3 at a constant speed in the X or Y direction. The image signal is converted into a multi-valued digital signal (gray level signal), which is then supplied to a difference detection unit 6 and also to a signal storage unit 5 to be stored therein. As the scanning proceeds, a gray level signal (inspection image signal) is generated from the adjacent die, in synchronism with which the gray level signal (reference image signal) of the preceding die is read out of the signal storage unit 5 and supplied to the difference detection unit 6. Actually, processing such as fine registration is also performed, but a detailed description of such processing will not be given here.

In this way, the gray level signals of the two adjacent dies are input to the difference detection unit 6 which computes the difference (gray level difference) between the two gray level signals and supplies the result to a detection threshold value calculation unit 7 and a defect detection unit 8.

Here, the difference detection unit 6 computes the absolute value of the gray level difference between corresponding pixels contained in the captured images of the two dies under comparison, and outputs it as the gray level difference. The detection threshold value calculation unit 7 determines the detection threshold value in accordance with the distribution of the gray level difference, and supplies the detection threshold value to the defect detection unit 8. The defect detection unit 8 compares the gray level difference with the thus determined threshold value to judge whether or not the portion under inspection is a defect or not.

Generally, the noise level of a semiconductor pattern differs depending on the kind of the pattern such as the pattern of a memory cell portion, the pattern of a logic circuit portion, the pattern of a wiring portion, or the pattern of an analog circuit portion. Correspondence between the portion and the kind of the semiconductor pattern can be found from the design data. Therefore, the detection threshold value calculation unit 7 determines the threshold value for each portion, for example, by performing threshold value determining processing, and the defect detection unit 8 performs the above judgment by using the threshold value determined for each portion. Then, for each portion that has been judged to be a defect, the defect detection unit 8 outputs defect information which includes defect parameters such as the position of the defect, the gray level difference, and the detection threshold value used for the detection.

After that, the defect information is supplied to an automatic defect classifying (ADC) apparatus (not shown) to examine the portion that has been judged to be a defect in further detail. The automatic defect classifying apparatus performs defect classification to determine whether the portion that has been judged to be a defect is a true defect that affects the yield or a false defect erroneously detected due to such effects as noise contained in the captured image, or to identify the kind of the defect (wiring lines shorts, missing features, particles, etc.).

The defect classification takes much processing time because each defective portion needs to be examined in detail. Therefore, when judging a defect, it is required that any true defect be judged to be a defect without fail, while minimizing the possibility of judging a non-true defect, i.e., a false defect, to be a defect.

In the defect inspection described in Japanese Unexamined Patent Publication (Kokai) No. 2004-177397, the occurrence of false defects is suppressed by determining an optimum detection threshold value for each inspection image in accordance with the distribution of the gray level difference associated with it. However, when the noise level contained in the inspection image has a large dependency on the inspection image, the distribution of the gray level difference greatly differs depending on the inspection image and, in such cases, it has been difficult to suppress the occurrence of false defects even if the threshold value is determined for each inspection image as described above.

### SUMMARY OF THE INVENTION

In view of the above problem, it is an object of the present invention to distinguish a true defect from a false defect in an image defect inspection that is performed by detecting a pixel value difference between corresponding pixels in two images and detecting that the pixel portion under inspection represents a defect when the difference exceeds a detection threshold value.

The present inventor noted the fact that, in the case of a true defect, pixels judged as representing defective portions because of the gray level difference between corresponding pixels in two images exceeding the threshold detection value tend to occur in a clustered fashion in the position of the defect, while in the case of a false defect, such defective portions are dispersed over a wide area.

Then, the inventor verified that, when the variance of the coordinate value of each pixel detected in the inspection image is computed by weighting the coordinate value in accordance with the gray level difference detected for each pixel, the variance becomes small when the inspection image contains a true defect but becomes large when the inspection image contains a false defect.

In view of the above, an image defect inspection apparatus according to a first aspect of the present invention is designed to detect a gray level difference between corresponding pixels in two inspection images and, if the gray level difference exceeds a detection threshold value, then to judge that one or the other of the pixels in the two inspection images represents a defect, the apparatus comprising: a variance computing unit which computes the variance of the coordinate value of the pixel by weighting the coordinate value in accordance with the gray level difference detected for the pixel (or with binarized information generated by binarizing the gray level difference); and a detection sensitivity reducing unit which reduces detection sensitivity for the defect the variance increases.

The detection sensitivity reducing unit may reduce the defect detection sensitivity by correcting the detection threshold value in accordance with the computed variance. Further, the image defect inspection apparatus may output the variance together with defect information concerning the detected defect.

An image defect inspection system apparatus according to a second aspect of the present invention comprises an image defect inspection apparatus and a defect classifying apparatus. The image defect inspection apparatus, which detects a gray level difference between corresponding pixels in two inspection images and which, if the gray level difference exceeds a detection threshold value, judges that one or the other of the pixels in the two inspection images represents a defect, comprises a variance computing unit which computes the variance of the coordinate value of the pixel by weighting the coordinate value in accordance with the gray level difference detected for the pixel (or with binarized information generated by binarizing the gray level difference), and the image defect inspection apparatus outputs the variance together with defect information concerning the detected defect. On the other hand, the defect classifying apparatus takes as inputs the variance and the defect information output from the image defect inspection apparatus, and classifies the defect based on the variance.

A defect classifying apparatus according to a third aspect of the present invention is an apparatus for classifying defect information that is output from an image defect inspection apparatus which detects a gray level difference between corresponding pixels in two inspection images and which, if the gray level difference exceeds a detection threshold value, judges that one or the other of the pixels in the two inspection images represents a defect, and the defect classifying apparatus comprises: a data input unit to which the defect information is input together with the variance that has been computed of the coordinate value of the pixel by the image defect inspection apparatus by weighting the coordinate value in accordance with the gray level difference detected for the pixel (or with the binarized information generated by binarizing the gray level difference); and a classifying unit which classifies the defect based on the variance.

An image defect inspection method according to a fourth aspect of the present invention detects a gray level difference between corresponding pixels in two inspection images and, if the gray level difference exceeds a detection threshold value, judges that one or the other of the pixels in the two inspection images represents a defect, wherein the variance of the coordinate value of the pixel is computed by weighting the coordinate value in accordance with the gray level difference detected for the pixel (or with the binarized information generated by binarizing the gray level difference), and detection sensitivity for the defect is reduced as the variance increases.

The reduction of the defect detection sensitivity may be accomplished by correcting the detection threshold value in accordance with the variance. Further, the image defect inspection method may classify the detected defect based on the variance.

According to the present invention, a true defect can be distinguished from a false defect in an image defect inspection that is performed by detecting a pixel value difference between corresponding pixels in two images and detecting the pixel portion under inspection as representing a defect when the difference exceeds a detection threshold value.

### BRIEF DESCRIPTION OF THE DRAWINGS

These and other objects and features of the present invention will become clearer from the following description of the preferred embodiments given with reference to the attached drawings, wherein:

FIG. 1 is a block diagram of a prior art appearance inspection apparatus for a semiconductor circuit.

FIG. 2 is a diagram showing the arrangement of dies on a semiconductor wafer;

FIG. 3 is a block diagram of an appearance inspection apparatus according to a first embodiment of an image defect inspection apparatus of the present invention.

FIG. 4A is a diagram showing an inspection image that does not contain any true defects.

FIG. 4B is a diagram showing a reference image.

FIG. 4C is a diagram showing a gray level difference image taken between the image shown in FIG. 4A and the image shown in FIG. 4B.

FIG. 5A is a diagram showing an inspection image that contains a true defect.

FIG. 5B is a diagram showing a reference image.

FIG. 5C is a diagram showing a gray level difference image taken between the image shown in FIG. 5A and the image shown in FIG. 5B.

FIG. 6 is a block diagram of an appearance inspection apparatus according to a second embodiment of the image defect inspection apparatus of the present invention.

FIG. 7 is a block diagram of an appearance inspection system according to an embodiment of an image defect inspection system of the present invention.

FIG. 8 is a block diagram of an appearance inspection apparatus according to a third embodiment of the image defect inspection apparatus of the present invention.

FIG. 9 is a block diagram of an automatic defect classifying apparatus according to an embodiment of a defect classifying apparatus of the present invention.

FIG. 10 is a block diagram of an appearance inspection apparatus according to a fourth embodiment of the image defect inspection apparatus of the present invention.

### DESCRIPTION OF THE PREFERRED EMBODIMENTS

Preferred embodiments of the present invention will be described in detail below by referring to the attached figures.

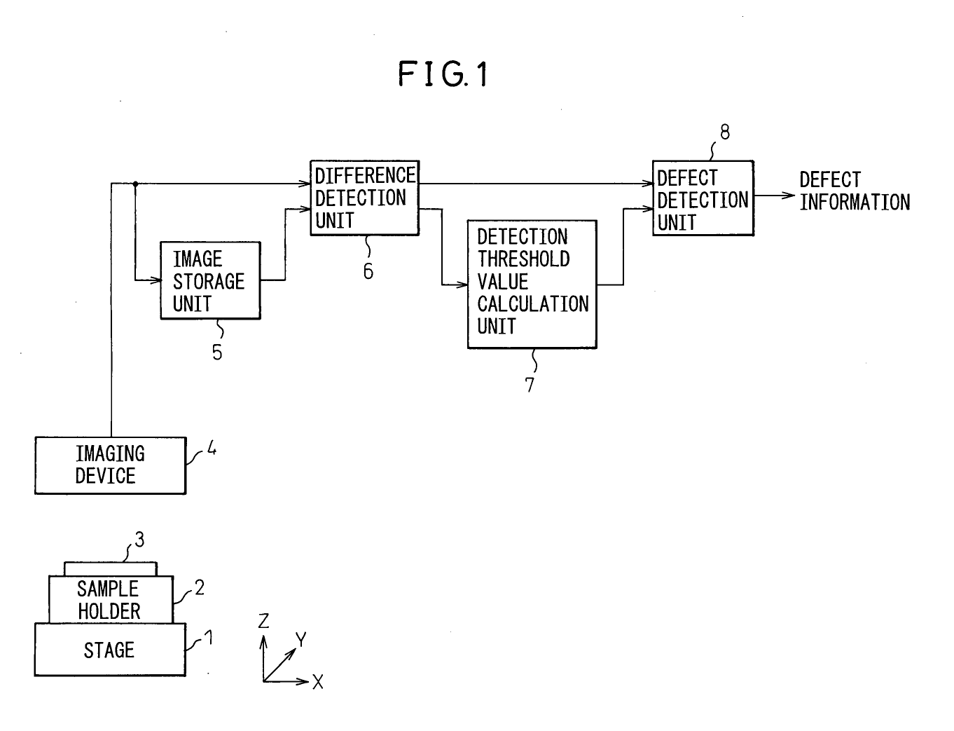

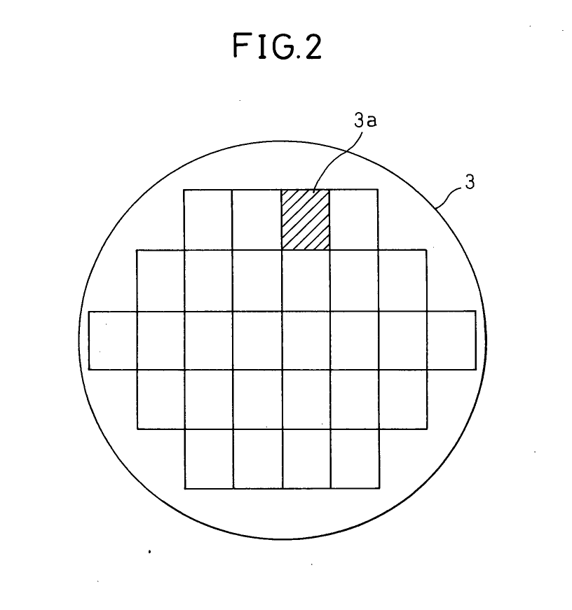

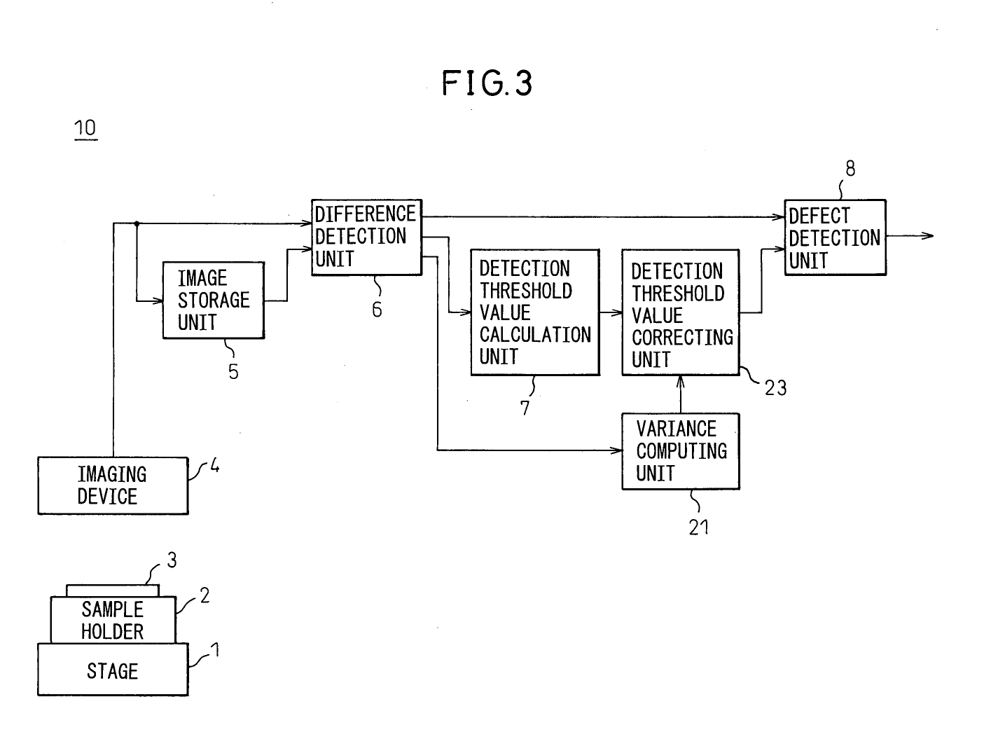

FIG. 3 is a block diagram of an appearance inspection apparatus according to a first embodiment of an image defect inspection apparatus of the present invention. The appearance inspection apparatus shown in FIG. 3 is similar in configuration to the prior art appearance inspection apparatus described with reference to FIG. 1; therefore, the same component elements are designated by the same reference numerals, and the description thereof will not be repeated here.

The difference detection unit 6 detects differences (gray level differences) between the pixel values (gray level signals) of the corresponding pixels contained in corresponding portions of two images captured of two dies (one image is taken as an inspection image, and the other as a reference image), and creates a difference image by mapping the difference signals to pixel values.

The appearance inspection apparatus 10 includes a variance computing unit 21 which takes as an input the difference image created by the difference detection unit 6 and computes the variance of the coordinate value of each pixel contained therein by weighting the coordinate value in accordance with the gray level difference signal representing the pixel value of that pixel, and a detection threshold value correcting unit 23 which corrects the detection threshold value calculated by the detection threshold value calculation unit 7 and reduces the defect detection sensitivity as the variance computed by the variance computing unit 21 increases.

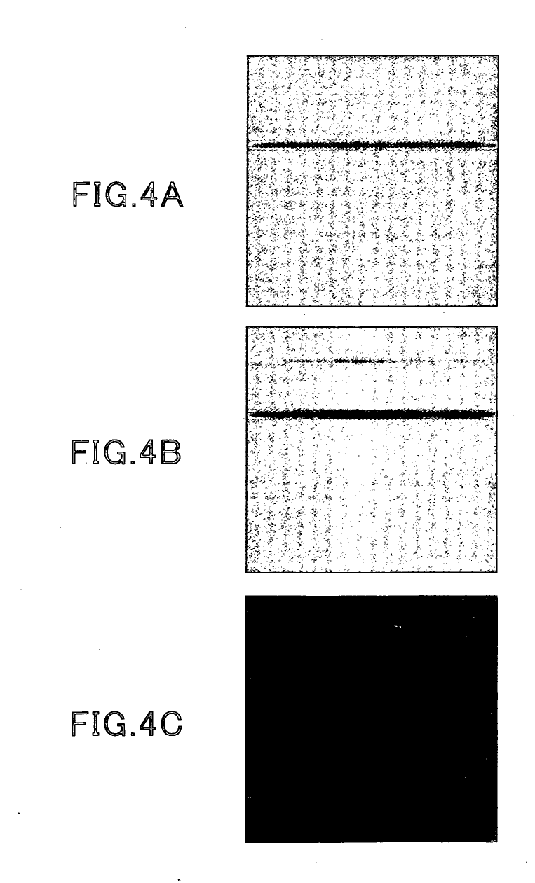

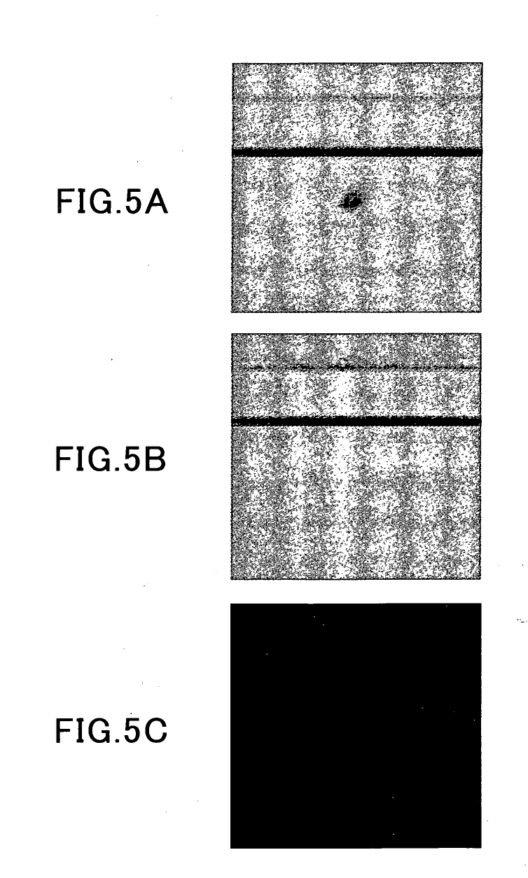

The principle of the present invention will be described below with reference to FIGS. 4A to 4C and 5A to 5C showing actual inspection images and reference images and the difference images computed from them. FIGS. 4A, 4B, and 4C show the inspection image, the reference image, and their difference image, respectively, for the case where no true defects are contained, while FIGS. 5A, 5B, and 5C show the inspection image, the reference image, and their difference image, respectively, for the case where a true defect is contained.

As can be seen from these images, in the difference image containing a true defect (FIG. 5C) there is a portion where pixels have significant gray level differences and, therefore, are detected as representing a defect, and occur in a clustered fashion. In contrast, in the difference image that does not contain any true defects (FIG. 4C), there are pixels having gray level differences, but these are false defects and are dispersed over the entire image, and there is no portion where such pixels occur in a clustered fashion as in the difference image containing a true defect.

Accordingly, when, in these difference images (FIGS. 4C and 5C), the variance of the coordinate value of each pixel is computed by weighting the coordinate value in accordance with the pixel value (gray level difference signal) of that pixel, the variance is small in the difference image containing a true defect (FIG. 5C), while the variance is large in the difference image containing false defects (FIG. 4C).

An example of a formula for calculating the variance of the coordinate value of each pixel weighted by the gray level difference (hereinafter simply referred to as the “variance”) is shown below. When the pixel value (i.e., the gray level difference) at coordinates (x, y) in the difference image is denoted by ΔGL (x, y), variances Devₓ and Dev_{y} for the X and Y directions, respectively, are calculated in accordance with equation (1) below.
[MATHEMATICAL 1]

$${Dev}_{x} = \sqrt{\frac{{W}_{tx} {\sum }_{x} {{x}^{2} ( Δ GL ( x , y ) )}^{n} - {( {\sum }_{x} {x ( Δ GL ( x , y ) )}^{n} )}^{2}}{{W}_{tx}^{2}}} \\ {Dev}_{y} = \sqrt{\frac{{W}_{ty} {\sum }_{y} {{y}^{2} ( Δ GL ( x , y ) )}^{n} - {( {\sum }_{y} {y ( Δ GL ( x , y ) )}^{n} )}^{2}}{{W}_{ty}^{2}}} \qquad ( 1 )$$

In equation (1), n is an arbitrary constant, and Wₜₓ and W_{ty} are respectively the total amounts of weights obtained by equation (2) below.
[MATHEMATICAL 2]

$${W}_{tx} = {\sum }_{x} {( Δ GL ( x , y ) )}^{n} \\ {W}_{ty} = {\sum }_{y} {( Δ GL ( x , y ) )}^{n} \qquad ( 2 )$$

Table 1 below shows examples of the variances Devₓ and Dev_{y} calculated using the above equation (1) for the difference images shown in FIGS. 4C and 5C. As can be seen from the table, the variances Devₓ and Dev_{y} are larger when the inspection image does not contain any true defects than when the inspection image contains a true defect.

[Table 1]

TABLE 1
CHANGE IN VARIANCE DUE TO
PRESENCE/ABSENCE OF DEFECT

| | | WITH | WITH |
|---|---|---|---|
| | | DEFECT | NO DEFECT |
| VARIANCE DEVₓ WEIGHTED | n = 2 | 22.86 | 28.74 |
| BY GRAY LEVEL DIFFERENCE | n = 4 | 9.15 | 28.27 |
| VARIANCE DEV_{y} WEIGHTED | n = 2 | 23.52 | 25.05 |
| BY GRAY LEVEL DIFFERENCE | n = 4 | 11.63 | 19.40 |

The variance computing unit 21 takes as an input the difference image created by the difference detection unit 6, and computes the variance (Devₓ, Dev_{y}) in the input difference image by using a calculation formula such as shown in the above equation (1). The detection threshold value correction unit 23 corrects the detection threshold value calculated by the detection threshold value calculation unit 7 and reduces the defect detection sensitivity of the defect detection unit 8 as the variance computed by the variance computing unit 21 increases. For example, the detection threshold value correction unit 23 may correct the detection threshold value calculated by the detection threshold value calculation unit 7 in such a manner as to increase the detection threshold value as the variance computed by the variance computing unit 21 increases.

By reducing the defect detection sensitivity of the defect detection unit 8 in accordance with an increase of the variance as described above, a region where false defects are likely to occur is detected, and the detection sensitivity in that region is reduced to prevent the occurrence of false defects.

In this and other embodiments herein described, the variance computing unit 21 may compute the variance (Devₓ, Dev_{y}) for each of the blocks into which the inspection image of the semiconductor wafer 3 under inspection is divided at intervals of an arbitrary number of pixels in the X and Y directions, and the detection threshold value calculated by the detection threshold value calculation unit 7 may be corrected on a segment-by-segment basis.

Usually, the difference image creation by the difference detection unit 6, the detection threshold value calculation by the detection threshold value calculation unit 7, and the defect detection by the defect detection unit 8 are performed for each of the sub-images, called logical frames, into which the inspection image of the semiconductor wafer 3 under inspection is divided at every prescribed number of pixels in the X and Y directions; accordingly, the variance computing unit 21 may compute the variance (Devₓ, Dev_{y}) for each logical frame.

As shown in FIGS. 4A and 4B, patterns corresponding to the patterns formed on the die 3 appear in the inspection image. As these pattern edges contain much noise, pixels in the difference image are prone to gray level differences, and the variance tends to become large in the image containing such edges.

That is, when there is color unevenness in a particular pattern portion in the inspection image or the reference image, if the variance is computed along the direction of that pattern, the variance becomes large, but if the variance is computed along the direction at right angles to the direction of that pattern, the variance becomes small because the pattern portion is concentrated.

Here, consider the case where the inspection image and the reference image have patterns oriented only in one of the X and Y directions in the images, as in the case of the patterns oriented in the X direction shown in FIGS. 4A and 4B, and where the variances Devₓ and Dev_{y} in the X and Y directions are computed on the difference image taken between such images. The following example deals with the case where the patterns in the reference image, etc. are oriented in the X direction, as shown in FIG. 4A.

When the variance Devₓ in the X direction extending along the pattern direction is computed, the variance Devₓ in the X direction tends to become large because the X coordinate value weighted by the gray level difference occurring in the edge portion changes along the direction (X direction) in which the variance is computed.

On the other hand, the variance Dev_{y} in the Y direction at right angles to the pattern direction is computed, the variance Dev_{y} in the Y direction becomes small because the Y coordinate value weighted by the gray level difference remains constant.

As a result, in the case where the inspection image and the reference image have patterns oriented only in one of the X and Y directions in the images, the variance may vary depending on the direction in which the variance is computed.

Accordingly, in this and other embodiments herein described, the detection threshold value correction unit 23 may compute both the variances Devₓ and Dev_{y} in the X and Y directions and may correct the detection threshold value in accordance with the larger variance or the mean value or the mean square value of the variances.

Further, in this and other embodiments herein described, the variance computing unit 21 may detect the direction of the pattern contained in the inspection image, etc. from which the difference image was computed, and may always compute the variance in the same direction as the detected pattern direction. Alternatively, the variance computing unit 21 may always compute the variance in the direction at right angles to the detected pattern direction.

For this purpose, the variance computing unit 21 may detect the pattern direction at the present inspection position on the inspection target (die or the like) from the present coordinate position of the stage 1 and the known pattern design data (such as CAD data) of the inspection target (die or the like). Alternatively, the variance computing unit 21 may detect the direction of the pattern contained in the inspection image by computing (by fast Fourier transform or the like) the spatial frequency components or spectral intensities of the inspection image from which the difference image was computed.

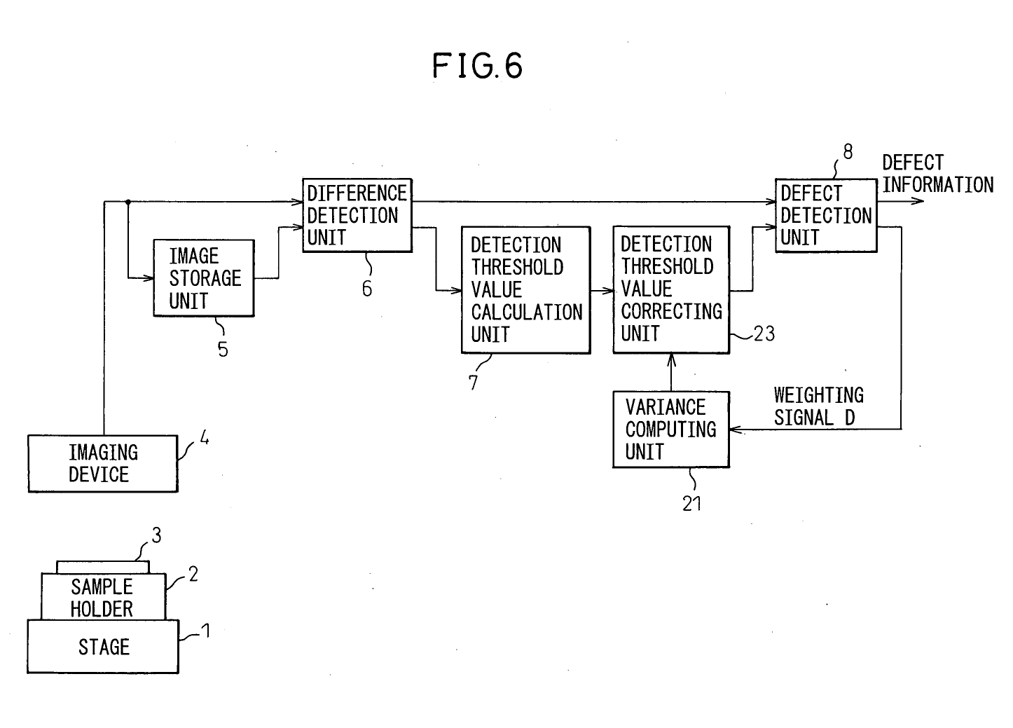

FIG. 6 is a block diagram of an appearance inspection apparatus according to a second embodiment of the image defect inspection apparatus of the present invention. In the embodiment shown in FIG. 6, the variance computing unit 21 computes the variance of the coordinate value of each pixel weighted in accordance with binarized information generated by binarizing the pixel value (gray level difference signal) of each pixel in the difference image created by the difference detection unit 6. In this method of variance computation, as the computation is performed only on pixels for which the binarized gray level difference signal has one or the other of the two values, the variance can be computed in a simpler manner.

In this case, the defect detection unit 8 compares each pixel in the difference image created by the difference detection unit 6 with the threshold value calculated by the detection threshold value calculation unit 7 and, if the gray scale difference exceeds the threshold value, then it judges the pixel value as representing a defect and outputs the defect information concerning the defect, while also outputting for each pixel in the difference image created by the difference detection unit 6 a weighting signal D which indicates whether the pixel value (gray level difference signal) exceeds a binarized threshold value Th. The weighting signal D may be determined as shown by equation (3) below.
[MATHEMATICAL 3]

$$D ( x , y ) = \{ \begin{matrix}0 , i f Δ GL ( x , y ) \leq Th \\ a , if Δ GL ( x , y ) > Th\end{matrix} \qquad ( 3 )$$

Here, “a” is a constant. This weighting signal D provides the binarized gray level difference signal. Then, the variance computing unit 21 takes as an input the weighting signal D (binarized gray level difference signal) output from the defect detection unit 8, and computes the variance (Devₓ, Dev_{y}) for the input difference image by using a calculation formula such as shown in equation (4) below.
[MATHEMATICAL 4]

$${Dev}_{x} = \sqrt{\frac{{W}_{tx} {\sum }_{x} {x}^{2} ( D ( x , y ) ) - {( {\sum }_{x} x ( D ( x , y ) ) )}^{2}}{{W}_{tx}^{2}}} \\ {Dev}_{y} = \sqrt{\frac{{W}_{ty} {\sum }_{y} {y}^{2} ( D ( x , y ) ) - {( {\sum }_{y} y ( D ( x , y ) ) )}^{2}}{{W}_{ty}^{2}}} \qquad ( 4 )$$

In equation (4), n is an arbitrary constant, and Wₜₓ and W_{ty} are respectively the total amounts of weights obtained by equation (5) below.
[MATHEMATICAL 5]

$${W}_{tx} = {\sum }_{x} ( D ( x , y ) ) \\ {W}_{ty} = {\sum }_{y} ( D ( x , y ) ) \qquad ( 5 )$$

Here, the binarized threshold value Th may be set to any suitable numerical value, but it may instead be set to the same value as the threshold value calculated by the threshold value calculation unit 7. In this case, the variance computed by the variance computing unit 21 becomes equal to the variance of the coordinate value of each pixel computed with the weighting coordinate value according to whether or not the pixel is judged to represent a defect by the defect detection unit 8.

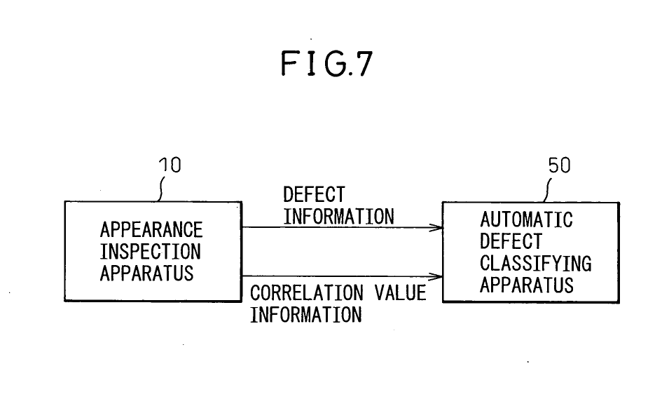

In the appearance inspection apparatus 10 described above with reference to FIGS. 3 and 6, the occurrence of false defects has been prevented by reducing the detection sensitivity as the variance increases but, alternatively, after detecting a defect, the detected defect may be classified according to the magnitude of the variance. An appearance inspection system implementing this is shown in FIG. 7.

The appearance inspection system comprises an appearance inspection apparatus 10 and an automatic defect classifying (ADC) apparatus 50 for classifying the defect information detected and output by the appearance inspection apparatus 10.

The variance is computed in the appearance inspection apparatus 10, and the variance information is supplied to the automatic defect classifying apparatus 50 together with the defect information concerning the detected defect. The automatic defect classifying apparatus 50 classifies the defect information based on the variance information (for example, according to the magnitude of the variance) and classifies the defect, for example, as a true defect or a false defect; here, if necessary, the defect information concerning the defect judged to be a false defect (for example, the variance value is larger than a predetermined threshold value) may be deleted.

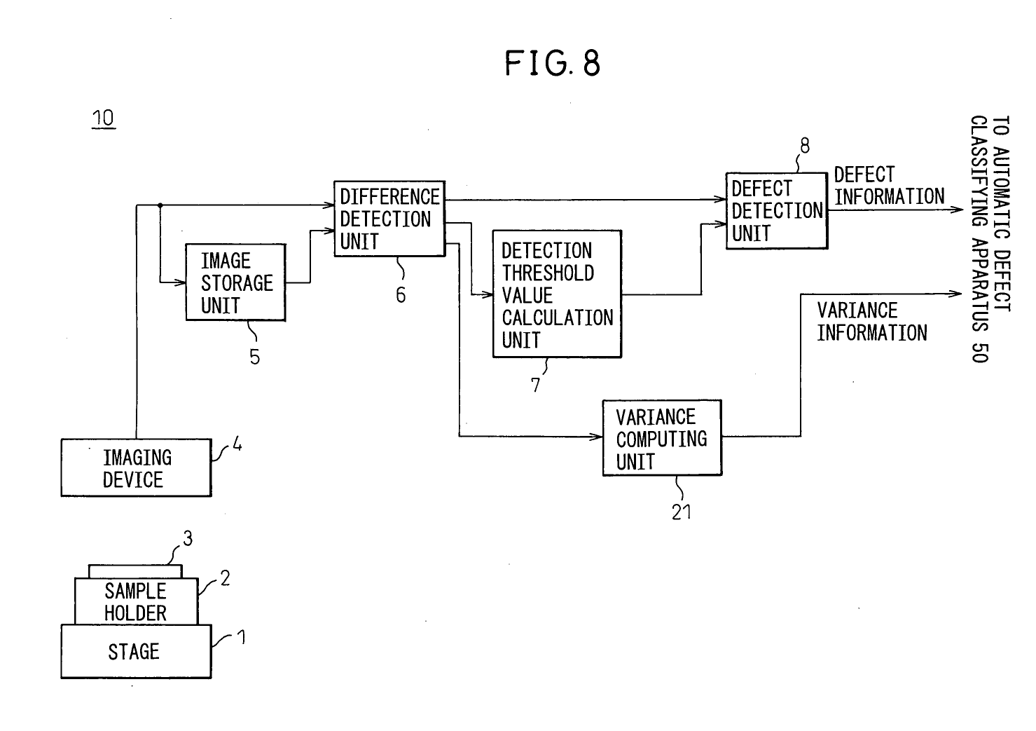

FIG. 8 is a block diagram of an appearance inspection apparatus according to a third embodiment of the image defect inspection apparatus of the present invention in the appearance inspection system shown in FIG. 7. The appearance inspection apparatus 10 supplies the variance information computed by the variance computing unit 21 to the automatic defect classifying apparatus 50 at the next stage together with (or by including therein) the defect information created by the defect detection unit 8.

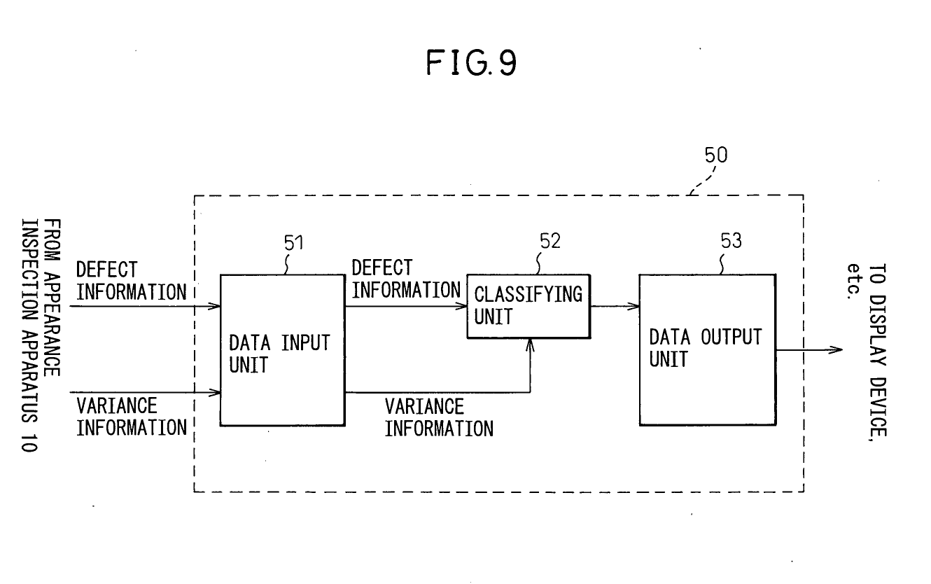

FIG. 9 is a block diagram showing an embodiment of the automatic defect classifying apparatus according to the present invention shown in FIG. 7. The automatic defect classifying apparatus 50 comprises a data input unit 51 to which the defect information and variance information output from the appearance inspection apparatus 10 are input, and a classifying unit 52 in which the defect information output from the appearance inspection apparatus 10 is classified according to various parameters contained in the defect information. Here, the data input unit 51 can be implemented, for example, as a drive device such as a flexible disk drive or a CD-ROM drive, a removable memory device, or a network interface such as a LAN adapter, while the classifying unit 52 can be implemented by a computing device such as a computer.

The classifying unit 52 classifies the defect information input via the data input unit 51 in accordance with the variance information input together with it. Here, the classifying unit 52 may classify the defect in the defect information, for example, as a false defect when the variance information input together with it exceeds a predetermined threshold value, and as a true defect when the variance information does not exceed the predetermined threshold value. Then, the automatic defect classifying apparatus 50 may supply only the defect information concerning the thus classified true defect, for example, to a display device or the like via a data output unit 53.

Further, based on the information contained in the defect information, the classifying unit 52 determines whether the defect information classified as representing a true defect really represents a true defect or a false defect, or identifies the kind of the defect (wiring lines shorts, missing features, particles, etc.).

In this way, the variance information is output together with the defect information, and the automatic defect classifying apparatus 50 classifies the detected defect as a true defect or a false defect; in this case also, the occurrence of false defects can be reduced, while enhancing the efficiency of the defect classification.

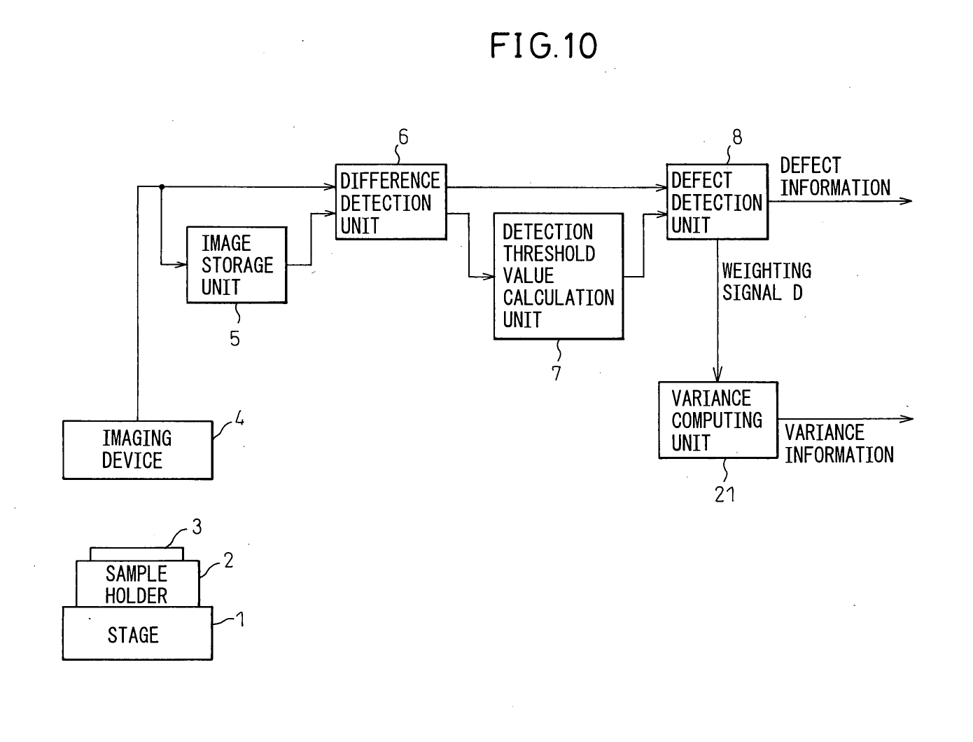

FIG. 10 is a block diagram of an appearance inspection apparatus according to a fourth embodiment of the image defect inspection apparatus of the present invention in the appearance inspection system shown in FIG. 7. The variance computing unit 21 shown in FIG. 10, like the variance computing unit 21 shown in FIG. 6, computes the variance of the coordinate value of each pixel weighted according to whether the pixel value (gray level difference signal) of each pixel in the difference image created by the difference detection unit 6 exceeds a predetermined value Th or not, and supplies the variance information to the automatic defect classifying apparatus 50 at the next stage together with (or by including therein) the defect information created by the defect detection unit 8.

The present invention is applicable to an image defect inspection apparatus, an image defect inspection system, and an image defect inspection method which detect a gray level difference between corresponding portions of two images, compare the detected gray level difference with a threshold value, and judge the portion under inspection to be a defect if the gray level difference is larger than the threshold value; the invention is also applicable to a defect classifying apparatus for classifying the thus detected defect.

While the invention has been described with reference to specific embodiments chosen for purpose of illustration, it should be apparent that numerous modifications could be made thereto, by those skilled in the art, without departing from the basic concept and scope of the invention.

What is claimed is:

1. An image defect inspection apparatus which detects a gray level difference between corresponding pixels in two inspection images and which, if said gray level difference exceeds a detection threshold value, judges that one or the other of said pixels in said two inspection images represents a defect, said apparatus comprising:
a variance computing unit which computes variance of a coordinate value of said pixel with weighting the coordinate value in accordance with said gray level difference detected for said pixel; and
a detection sensitivity reducing unit which reduces detection sensitivity for said defect as said variance increases.

2. An image defect inspection apparatus which detects a gray level difference between corresponding pixels in two inspection images and which, if said gray level difference exceeds a detection threshold value, judges that one or the other of said pixels in said two inspection images represents a defect, said apparatus comprising:
a variance computing unit which computes variance of a coordinate value of said pixel by weighting the coordinate value in accordance with binarized information generated by binarizing said gray level difference detected for said pixel; and
a detection sensitivity reducing unit which reduces detection sensitivity for said defect as said variance increases.

3. An image defect inspection apparatus as claimed in claim 2, wherein said variance computing unit computes the variance of the coordinate value of said pixel by weighting the coordinate value according to whether said pixel has been judged to represent a defect or not.

4. An image defect inspection apparatus as claimed in any one of claims 1 to 3, wherein said variance computing unit corrects said detection threshold value in accordance with said variance.

5. An image defect inspection apparatus which detects a gray level difference between corresponding pixels in two inspection images and which, if said gray level difference exceeds a detection threshold value, judges that one or the other of said pixels in said two inspection images represents a defect, said apparatus comprising:
a variance computing unit which computes variance of a coordinate value of said pixel by weighting the coordinate value in accordance with said gray level difference detected for said pixel, wherein
said image defect inspection apparatus outputs said variance together with defect information concerning said detected defect.

6. An image defect inspection apparatus which detects a gray level difference between corresponding pixels in two inspection images and which, if said gray level difference exceeds a detection threshold value, judges that one or the other of said pixels in said two inspection images represents a defect, said apparatus comprising:
a variance computing unit which computes variance of a coordinate value of said pixel by weighting the coordinate value in accordance with binarized information generated by binarizing said gray level difference detected for said pixel, wherein
aid image defect inspection apparatus outputs said variance together with defect information concerning said detected defect.

7. An image defect inspection apparatus as claimed in claim 6, wherein said variance computing unit computes the variance of the coordinate value of said pixel by weighting the coordinate value according to whether said pixel has been judged to represent a defect or not.

8. An image defect inspection system comprising:
an image defect inspection apparatus which detects a gray level difference between corresponding pixels in two inspection images and which, if said gray level difference exceeds a detection threshold value, judges that one or the other of said pixels in said two inspection images represents a defect, said apparatus comprising a variance computing unit which computes variance of a coordinate value of said pixel by weighting the coordinate value in accordance with said gray level difference detected for said pixel, wherein said image defect inspection apparatus outputs said variance together with defect information concerning said detected defect; and
a defect classifying apparatus which takes, as inputs, said variance and said defect information output from said image defect inspection apparatus, and classifies said defect based on said variance.

9. An image defect inspection system comprising:
an image defect inspection apparatus which detects a gray level difference between corresponding pixels in two inspection images and which, if said gray level difference exceeds a detection threshold value, judges that one or the other of said pixels in said two inspection images represents a defect, said apparatus comprising a variance computing unit which computes variance of a coordinate value of said pixel by weighting the coordinate value in accordance with binarized information generated by binarizing said gray level difference detected for said pixel, wherein said image defect inspection apparatus outputs said variance together with defect information concerning said detected defect; and
a defect classifying apparatus which takes as inputs said variance and said defect information output from said image defect inspection apparatus, and classifies said defect based on said variance.

10. An image defect inspection system as claimed in claim 9, wherein said variance computing unit computes the variance of the coordinate value of said pixel by weighting the coordinate value according to whether said pixel has been judged to represent a defect or not.

11. A defect classifying apparatus for classifying defect information received from an image defect inspection apparatus, wherein said image defect inspection apparatus detects a gray level difference between corresponding pixels in two inspection images and judges that one or the other of said pixels in said two inspection images represents a defect when said gray level difference exceeds a detection threshold value, said defect classifying apparatus comprising:
a data input unit to which said defect information is input together with variance that has been computed of a coordinate value of said pixel by said image defect inspection apparatus by weighting the coordinate value in accordance with said gray level difference detected for said pixel; and
a classifying unit which classifies said defect based on said variance.

12. A defect classifying apparatus for classifying defect information received from an image defect inspection apparatus, wherein said image defect inspection apparatus detects a gray level difference between corresponding pixels in two inspection images and judges that one or the other of said pixels in said two inspection images represents a defect when said gray level difference exceeds a detection threshold value, said defect classifying apparatus comprising:
a data input unit to which said defect information is input together with variance that has been computed of a coordinate value of said pixel by said image defect inspection apparatus by weighting the coordinate value in accordance with binarized information generated by binarizing said gray level difference detected for said pixel; and
a classifying unit which classifies said defect based on said variance.

13. A defect classifying apparatus as claimed in claim 12, wherein said image defect inspection apparatus computes the variance of the coordinate value of said pixel with weighting the coordinate value according to whether said pixel has been judged to represent a defect or not.

14. An image defect inspection method which detects a gray level difference between corresponding pixels in two inspection images and which, if said gray level difference exceeds a detection threshold value, judges that one or the other of said pixels in said two inspection images represents a defect, wherein
variance of a coordinate value of said pixel is computed by weighting the coordinate value in accordance with said gray level difference detected for said pixel, and
the detection sensitivity for said defect is reduced as said variance increases.

15. An image defect inspection method which detects a gray level difference between corresponding pixels in two inspection images and which, if said gray level difference exceeds a detection threshold value, judges that one or the other of said pixels in said two inspection images represents a defect, wherein
variance of a coordinate value of said pixel is computed by weighting the coordinate value in accordance with binarized information generated by binarizing said gray level difference detected for said pixel, and
the detection sensitivity for said defect is reduced as said variance increases.

16. An image defect inspection method as claimed in claim 15, wherein the variance of the coordinate value of said pixel is computed by weighting the coordinate value according to whether said pixel has been judged to represent a defect or not.

17. An image defect inspection method as claimed in any one of claims 14 to 16, wherein said detection sensitivity is reduced by correcting said detection threshold value in accordance with said variance.

18. An image defect inspection method which detects a gray level difference between corresponding pixels in two inspection images and which, if said gray level difference exceeds a detection threshold value, judges that one or the other of said pixels in said two inspection images represents a defect, wherein
variance of a coordinate value of said pixel is computed by weighting the coordinate value in accordance with said gray level difference detected for said pixel, and
said detected defect is classified based on said variance.

19. An image defect inspection method which detects a gray level difference between corresponding pixels in two inspection images and which, if said gray level difference exceeds a detection threshold value, judges that one or the other of said pixels in said two inspection images represents a defect, wherein
variance of a coordinate value of said pixel is computed by weighting the coordinate value in accordance with binarized information generated by binarizing said gray level difference detected for said pixel, and
said detected defect is classified based on said variance.

20. An image defect inspection method as claimed in claim 19, wherein the variance of the coordinate value of said pixel is computed by weighting the coordinate value according to whether said pixel has been judged to represent a defect or not.
